(19) United States
(12) Patent Application Publication
(10) Pub. No.: US 2026/0302165 A1
(43) Pub. Date: Oct. 1, 2026

(54) ELECTRODE ASSEMBLY AND SECONDARY BATTERY INCLUDING THE ELECTRODE ASSEMBLY

(71) Applicant: SAMSUNG SDI CO., LTD., Yongin-si (KR)

(72) Inventor: Young Kwang YUN, Yongin-si (KR)

(21) Appl. No.: 19/300,944

(22) Filed: Aug. 15, 2025

(30) Foreign Application Priority Data
Mar. 31, 2025 (KR) 10-2025-0041010

(51) Int. Cl. H01M 4/133; H01M 4/02; H01M 4/134; H01M 4/38; H01M 4/587; H01M 10/0525; H01M 10/0587; H01M 50/46; H01M 50/533

(52) U.S. Cl. CPC H01M 4/133; H01M 4/134; H01M 4/386; H01M 4/587; H01M 10/0525; H01M 10/0587; H01M 50/46; H01M 50/533; H01M 2004/021; H01M 2004/027

(57) ABSTRACT

An electrode assembly includes a positive electrode plate, a negative electrode plate, and separator interposed between the positive electrode plate and the negative electrode plate. The negative electrode plates includes (i) a negative electrode substrate, (ii) a negative electrode active material layer formed as a coating two regions of the negative electrode substrate, with the two regions comprising different active materials, and (iii) a negative electrode uncoated portion not provided with the negative electrode active material layer.

### CROSS-REFERENCE TO THE RELATED APPLICATION

The present application claims priority to and the benefit of Korean Patent Application No. 10-2025-0041010, filed on Mar. 31, 2025, in the Korean Intellectual Property Office, the entire disclosure of which is incorporated herein by reference.

### BACKGROUND

### 1. Field

Aspects of the present disclosure relate to an electrode assembly and a secondary battery including the electrode assembly.

### 2. Description of the Related Art

Unlike primary batteries that are not designed to be (re)charged, secondary (or rechargeable) batteries are batteries that are designed to be discharged and recharged. Low-capacity secondary batteries are used in portable small electronic devices, such as smart phones, feature phones, notebook(laptop) computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The information disclosed in this section is provided only for enhancement of understanding of the background of the disclosure and therefore it may contain information that does not constitute related (or the prior) art.

### SUMMARY

An aspect of the present disclosure is to provide an electrode assembly including a negative electrode plate having an improved structure and a secondary battery including the negative electrode plate.

These and other aspects and features of the present disclosure will be described in or will be apparent from the following description of embodiments of the present disclosure.

An electrode assembly according to an embodiment of the present disclosure includes a positive electrode plate, a negative electrode plate, with including a negative electrode substrate, a negative electrode active material layer formed as a coating in two regions of the negative electrode substrate, with the two regions comprising different active materials, and (iii) a negative electrode uncoated portion not provided with the negative electrode active material layer, and a separator interposed between the positive electrode plate and the negative electrode plate.

The negative electrode plate may further include a negative electrode tab formed by notching the negative electrode uncoated portion.

The negative electrode plate, the positive electrode plate, and the separator may be wound with the separator interposed between the positive electrode plate and the negative electrode plate.

Each of the negative electrode plate, the positive electrode plate, and the separator may be provided in plural, and the plurality of negative electrode plates, the plurality of positive electrode plates, and the plurality of separators may be stacked with each of the plurality of separators interposed between one of the plurality of positive electrode plates and one of the plurality of negative electrode plates.

The negative electrode tab may be disposed on one side of the negative electrode plate.

The negative electrode active material layer may include a first active material layer formed by coating with a first material and a second active material layer formed by coating with a second material.

The second active material layer may be disposed adjacent to the negative electrode tab. an area of the first active material layer may be larger than an area of the second active material layer.

The second material may have a larger lithium storage capacity than the first material.

The first material may include graphite, and the second material may include silicon or a mixture containing silicon.

A length of the second active material layer may be less than a length (L1) of the first active material layer in the longitudinal direction of the negative electrode tab.

The length (L2) of the second active material layer may be 5% to 50% of the length (L1) of the first active material layer.

A thickness of the second active material layer may have a thickness (t2) is less than a thickness (t1) of the first active material layer in a direction perpendicular to the longitudinal direction of the negative electrode tab.

The thickness (t2) of the second active material layer may be 20% to 50% of the thickness (t1) of the first active material layer.

A plurality of the negative electrode tab may be provided, and the positive electrode plate may include a plurality of positive electrode tabs.

Each of the negative electrode plates may include at least one negative electrode tab, and each of the positive electrode plates may include at least one positive electrode tab.

A secondary battery according to an embodiment of the present disclosure includes a case, and an electrode assembly including a positive electrode plate, a negative electrode plate, and a separator interposed between the positive electrode plate and the negative electrode plate, with the negative electrode plate including (i) a negative electrode substrate, (ii) a negative electrode active material layer formed as a coating in two regions of the negative electrode substrate, with the two regions comprising different active materials, and (iii) at least one negative electrode tab disposed on one side of the negative electrode active material layer.

The negative electrode active material layer may include a first active material layer formed by coating with a first material and a second active material layer formed by coating with a second material having a larger lithium storage capacity than the first material.

The second active material layer may be disposed adjacent to a negative electrode tab.

An area of the first active material layer may be larger than an area of the second active material layer.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a schematic view of an exemplary active material coating process for a negative electrode plate;

FIG. 2 is a side view of the active material coating process for the negative electrode plate shown in FIG. 1;

FIG. 3 is a schematic view showing regions in which by-products are generated and ions are plated in the negative electrode plate shown in FIGS. 1 and 2;

FIG. 4 is a view showing a deviation in the state of charge (SoC) of the negative electrode plate shown in FIGS. 1 and 2;

FIG. 5 is a schematic view of an active material coating process for a negative electrode plate according to an embodiment of the present disclosure;

FIG. 6 is a schematic view of an active material coating process for a negative electrode plate according to another embodiment of the present disclosure;

FIG. 7 is a side view of the active material coating process for the negative electrode plate shown in FIG. 6;

FIG. 8 is a plan view showing a portion of the negative electrode plate shown in FIG. 5 or 6;

FIG. 9 is a side cross-sectional view of the negative electrode plate shown in FIG. 8;

FIG. 10 is a perspective view of an exemplary electrode assembly to which the negative electrode plate according to the embodiments of the present disclosure is applied;

FIG. 11 is a perspective view of an exemplary secondary battery to which the electrode assembly shown in FIG. 10 is applied; and

FIG. 12 is a plan view of another exemplary electrode assembly to which the negative electrode plate according to the embodiments of the present disclosure is applied.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Additionally, in order to facilitate understanding of the invention, the attached drawings are not drawn to scale and the dimensions of some components may be exaggerated. Additionally, the same reference numbers may be assigned to the same components in different embodiments.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the disclosure.

An exemplary negative electrode plate and an active material coating process will be described with reference to the accompanying drawings.

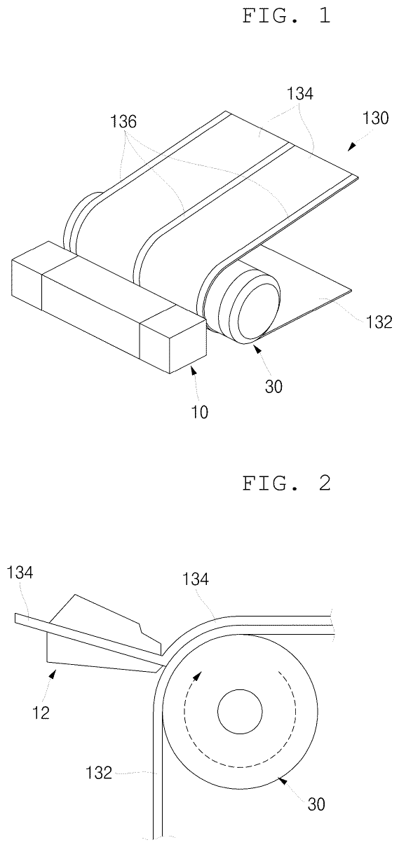

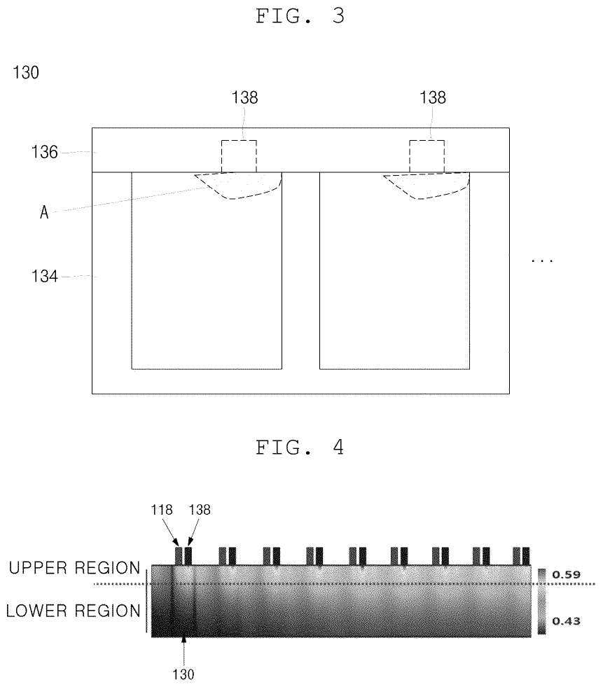

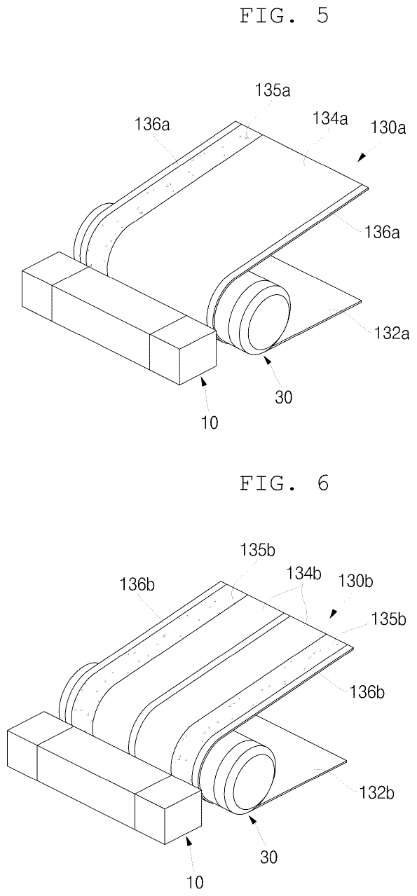

FIG. 1 is a schematic view of an exemplary active material coating process for a negative electrode plate. FIG. 2 is a side view showing the active material coating process for the negative electrode plate shown in FIG. 1. FIG. 3 is a schematic view showing regions in which by-products are generated and ions are plated in the negative electrode plate shown in FIGS. 1 and 2. FIG. 4 is a view showing a deviation in the state of charge (SoC) of the negative electrode plate shown in FIGS. 1 and 2.

FIG. 1 shows a “stripe coating” that is an exemplary active material coating process. In stripe coating, an active material is applied in the form of one or more stripes. An electrode substrate may be striped coating with the active material, with uncoated portions where active material is not striped coated forming a plurality of tabs. Because the finally formed active material layer has a stripe pattern, this active material coating process is referred to as stripe coating.

Referring to FIGS. 1 and 2, in order to manufacture the negative electrode plate 130, a negative electrode active material may be coated in two lines on a negative electrode substrate 132 to form a negative electrode active material layer 134. Negative electrode uncoated portions 136 where the negative electrode active material is not provided may be formed on both sides of the negative electrode plate 130 in the longitudinal direction. If the negative electrode substrate 132 is cut along the central negative electrode uncoated portion 136, the negative electrode plate 130 may be divided into a left negative electrode plate and a right negative electrode plate. The negative electrode substrate 132 may be supplied by a rotary support member 30, such as a roller. A coating device 10 may include a nozzle 12 that dispenses slurry as an active material. The slurry may be applied to the negative electrode substrate 132 through the nozzle 12 to form the negative electrode active material layer 134. The negative electrode active material layer 134 may be provided on one surface or both surfaces of the negative electrode substrate 132. For example, after the negative electrode active material layer 134 is formed on one surface of the negative electrode substrate 132 through the above-described method and then dried, the same coating process may be performed on the opposite surface of the negative electrode substrate 132.

FIG. 3 shows a portion of the negative electrode plate manufactured through the above-described process of coating the negative electrode active material layer. During the process of manufacturing the negative electrode plate 130, the negative electrode uncoated portion 136 may be shaped to form a negative electrode tab 138. An exemplary shape of the negative electrode tab 138 is indicated by a dotted line in FIG. 3. If the negative electrode plate 130 in this state is wound together with a positive electrode plate and a separator, a wound-type electrode assembly may be formed. A plurality of negative electrode tabs 138 may be formed, and, thus, the negative electrode plate 130 include multiple tabs 138. The positive electrode plate may also be manufactured in the same manner and may include multiple tabs. In other embodiments, if the negative electrode plate 130 is cut into a plurality of pieces of a predetermined size based on the negative electrode tabs 138 and the resulting pieces are stacked together with a positive electrode plate and a separator, a stacked-type electrode assembly may be formed. In such a configuration, because the negative electrode plate 130 is divided into a plurality of pieces, the negative electrode plate may be implemented in a multi-tab form including a plurality of negative electrode tabs 138. The positive electrode plate may also be manufactured in the same manner and may include multiple tabs. The shape of the negative electrode plate 130 resulting from cutting the negative electrode plate 130 is indicated by solid lines on the negative electrode active material layer 134 in FIG. 3.

During charging of a secondary battery, current may flow through a negative electrode tab. A relatively high current density may be formed in the vicinity of the negative electrode tab where the flow of current is concentrated. Due to the localized concentration of current, the charging rate in the corresponding region may increase, resulting in rapid insertion of lithium ions and an increased load. This phenomenon may become more pronounced in a negative electrode plate that includes a plurality of negative electrode tabs. The central portion and the lower portion (lower portion based on FIG. 4, which will be described later) of the negative electrode plate may have relatively low current density such that charging and discharging are smoothly performed and lithium plating does not occur therein.

If the charging rate is high or the local current density increases, lithium ions may be supplied to the surface of the negative electrode plate at a rate higher than the rate at which the lithium ions are absorbed. In such a case, the lithium ions may be electrically attached to the surface of. the negative electrode plate and may be plated in the form of metallic lithium. When silicon is used as the electrode material, the diffusion rate of lithium ions may be lower and the volume change during charging and discharging may be greater than when graphite is used as the electrode material. Therefore, the problem of lithium plating may be aggravated in a specific region (indicated as “A” in FIG. 3).

Silicon has a large lithium storage capacity but undergoes a significant volume change of up to 300% during charging and discharging. As a result, mechanical stress in the electrode increases and internal structural deformation occurs during charging and discharging. In regions in which expansion is severe, stress concentration may occur within the electrode, and decomposition reactions of the electrolyte may be accelerated, thereby increasing the formation of by-products such as a solid electrolyte interphase (SEI) layer. For example, if the charging load is concentrated near the negative electrode tab, the expansion of the silicon may be further accelerated, potentially causing problems such as collapse in the pore structure and deterioration of lithium ion diffusion.

Because silicon undergoes a significant volume change during charging and discharging, the solid electrolyte interphase (SEI) layer may be repeatedly broken and reformed. As the SEI layer becomes thicker, the diffusion rate of lithium ions may decrease, and the internal resistance may increase, thereby degrading battery performance. For example, the growth rate of the SEI layer may be accelerated near the negative electrode tab due to current concentration and lithium plating, and the available capacity may decrease due to increase in inactive lithium after prolonged use. Further, if mechanical stress accumulates within the electrode due to expansion of silicon, contact between the electrode active material and the substrate may weaken, and cracking may occur in the electrode. If cracking occurs, the electrolyte may permeate the electrode, which may lead to additional side reactions, thereby increasing the likelihood of long-term reliability degradation and gas generation. If cracking occurs near the negative electrode tab, current paths may become unbalanced, and heat generation and performance degradation may be accelerated due to increase in internal resistance. Therefore, it is necessary to address such problems.

FIG. 4 shows the state of charge (SoC) of the negative electrode plate measured when the secondary battery is charged with 2C-rate current (2C; current corresponding to twice the rated capacity of the battery per hour) and constant current (CC). The values on the right side of FIG. 4 represent voltage (V). In FIG. 4, regions of the negative electrode plate 130 having a difference in SoC of 0.1 V or greater are distinguished by a dotted line. A dotted line is indicated at the position on the negative electrode plate (130) where the SoC differs by 0.1 V or more. Accordingly, the dotted line is shown at the position where the SoC is 0.53 V. For example, the region of the negative electrode plate (130) where the SoC is 0.43 V, based on the dotted line, may be referred to as the “lower region.” Conversely, the region where the SoC is 0.53 V or higher may be referred to as the “upper region.” In this configuration, the lower region may serve as a first active material layer on which a first active material (described below) is coated. The upper region may serve as a second active material layer on which a second active material (described below) is coated. The region in which the deviation in SoC is 0.1 V or greater is defined as the upper region. The upper region defined in this manner may be regarded as a region in which the lithium ion plating and by-product generation are severe and improvement is required. As described above, the SoC value may serve as a criterion for defining an active material coating region.

Next, a negative electrode plate and an active material coating process according to embodiments of the present disclosure will be described.

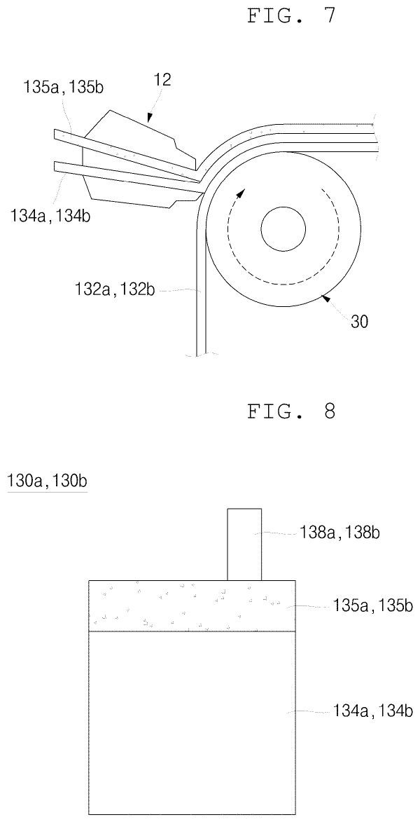

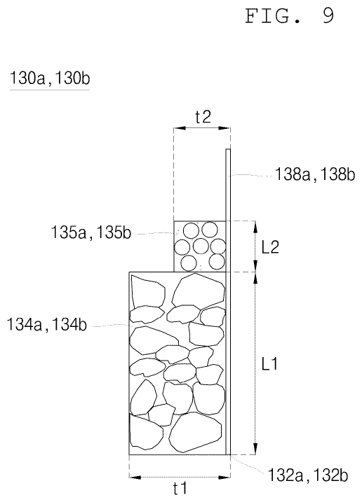

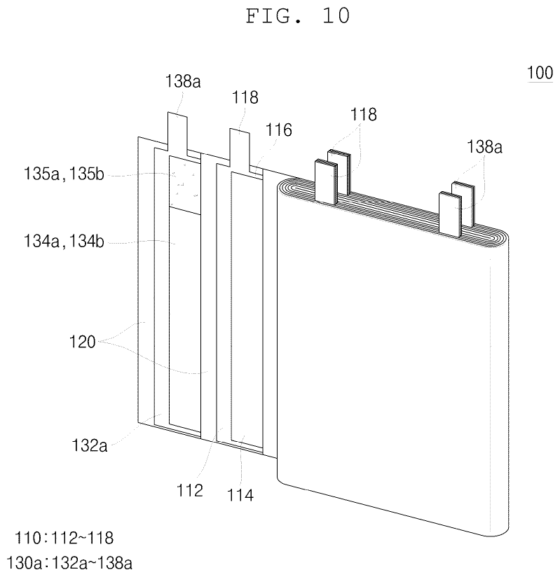

FIG. 5 is a schematic view showing an active material coating process for a negative electrode plate according to an embodiment of the present disclosure. FIG. 6 is a schematic view showing an active material coating process for a negative electrode plate according to another embodiment of the present disclosure. FIG. 7 is a side view showing the active material coating process for the negative electrode plate shown in FIG. 6. FIG. 8 is a plan view showing a portion of the negative electrode plate shown in FIG. 5 or 6. FIG. 9 is a side cross-sectional view of the negative electrode plate shown in FIG. 8.

Referring to FIG. 5, an active material coating process for a negative electrode plate according to an embodiment of the present disclosure may be used for manufacturing a single wound-type negative electrode plate 130a. Negative electrode uncoated portions 136a may be provided at both ends of an active material layer in the longitudinal direction. The active material layer may include a first active material layer 134a and a second active material layer 135a formed by coating two active materials. The first active material layer 134a and the second active material layer 135a may collectively be referred to as a single active material layer. That is, the negative electrode plate 130a manufactured through the coating process shown in FIG. 5 may include the first active material layer 134a and the second active material layer 135a. Slurry forming each of the first active material layer 134a and the second active material layer 135a may be supplied by a coating device 10. A negative electrode substrate 132a may be supplied to the coating device 10 by a support member 30. In some embodiments, the first active material layer 134a and the second active material layer 135a may not overlap each other. In other embodiments, the first active material layer 134a and the second active material layer 135a may contact each other without a gap therebetween. If the negative electrode plate 130a manufactured in this manner is wound together with a positive electrode plate and a separator, a wound-type electrode assembly may be formed. In other embodiments, if the negative electrode plate 130a manufactured in this manner is cut into a plurality of pieces of a predetermined size, as shown in FIG. 3, and then the resulting pieces are stacked together with a positive electrode plate and a separator, a stacked-type electrode assembly may be formed.

Referring to FIG. 6, an active material coating process for a negative electrode plate according to another embodiment of the present disclosure may form two wound-type negative electrode plates 130b. Negative electrode uncoated portions 136b may be provided at both ends and the center of an active material layer in the longitudinal direction. The active material layer located between the negative electrode uncoated portions 136b provided at one end and the center of the active material layer may include a first active material layer 134b and a second active material layer 135b formed by coating two active materials. The active material layer located between the negative electrode uncoated portions 136b provided at the other end and the center of the active material layer may also include a first active material layer 134b and a second active material layer 135b formed by coating two active materials. If the negative electrode plate 130b is cut along the center negative electrode uncoated portion 136b, two negative electrode plates 130b may be formed. Each of the two negative electrode plates 130b made through the coating process shown in FIG. 6 may include the first active material layer 134b and the second active material layer 135b. Slurry forming each of the first active material layer 134b and the second active material layer 135b may be supplied by the coating device 10. A negative electrode substrate 132b may be supplied to the coating device 10 by the support member 30. In some embodiments, the first active material layer 134b and the second active material layer 135b may not overlap each other. In other embodiments, the first active material layer 134b and the second active material layer 135b may contact with each other without a gap therebetween. If the negative electrode plate 130b manufactured in this manner is wound together with a positive electrode plate and a separator, a wound-type electrode assembly may be formed. In other embodiments, if the negative electrode plate 130b manufactured in this manner is cut into a plurality of pieces of a predetermined size and then the resulting pieces are stacked together with a positive electrode plate and a separator, a stacked-type electrode assembly may be formed.

Referring to FIG. 7, the coating device 10 may include a nozzle 12 that applies slurry for forming the first active material layer 134a or 134b and slurry for forming the second active material layer 135a or 135b. Because FIG. 7 is a side view, the slurries applied through the nozzle 12 are shown in an overlapping manner. However, as described above, the first active material layer 134a or 134b and the second active material layer 135a or 135b do not overlap each other but are applied in parallel as shown in FIG. 5 or 6. Although not shown in detail in the drawings, the nozzle 12 may include two internal passages, and different slurries may be discharged through the two internal passages of the nozzle 12. Each of the first active material layer 134a or 134b and the second active material layer 135a or 135b may be formed to have a predetermined width. Herein, width refers to a length in a direction perpendicular to the coating direction of the active material layer.

FIG. 8 shows a portion of the negative electrode plate 130a or 130b manufactured through the above-described process shown in FIG. 5 or 6. FIG. 9 shows the side surface of the negative electrode plate 130a or 130b shown in FIG. 8.

Referring to FIGS. 8 and 9, the first active material layer 134a or 134b may be formed of a first material. The first active material layer 134a or 134b may be formed to have a larger area than the second active material layer 135a or 135b. The first active material layer 134a or 134b may be coated to have a length indicated by L1 and a thickness indicated by t1. For example, based on the orientation shown in FIGS. 5 and 6, the length indicated by L1 corresponds to the width of the first active material layer 134a or 134b. In another embodiment shown in FIG. 8, the length indicated by L1 corresponds to the length in a direction parallel to the negative electrode tab 138a or 138b. The second active material layer 135a or 135b may be coated to have a length indicated by L2 and a thickness indicated by t2. For example, based on the orientation shown in FIGS. 5 and 6, the length indicated by L2 may correspond to the width of the second active material layer 135a or 135b. In another embodiment shown in FIG. 8, the length indicated by L2 may correspond to the length in a direction parallel to the negative electrode tab 138a or 138b. The length L1 of the first active material layer 134a or 134b may be greater than the length L2 of the second active material layer 135a or 135b, and the thickness t1 of the first active material layer 134a or 134b may be greater than the thickness t2 of the second active material layer 135a or 135b. The length L2 of the second active material layer 135a or 135b may correspond to the length (width) of the “upper region” defined in the above description with reference to FIG. 4. The length L2 of the second active material layer 135a or 135b may vary depending on the type of the negative electrode tab 138a or 138b, the size of the negative electrode plate 130a or 130b, or the charging/discharging current rate (C-rate). In specific examples, the thickness t2 of the second active material layer 135 a or 135 b may be ⅕ to ½ (20 % to 50%) of the thickness t1 of the first active material layer 134a or 134b. And the length L2 of the second active material layer 135a or 135b may be 1/20 to ½ (5 % to 50%) of the length L1 of the first active material layer 134a or 134b.

The first material may be, for example, graphite. The second material may be, for example, silicon (including SiC, SiOx, or the like). Because silicon has a specific capacity of approximately 1800 mAh/g, which is about five times higher than that of graphite (approximately 360 mAh/g), the same capacity may be achieved even when silicon is coated to a thickness that is one-fifth that of graphite. The second active material layer 135a or 135b may be formed using only the second material. The first active material layer 134a or 134b may be formed using only the first material or a mixture of graphite and silicon. Although silicon exhibits a high expansion ratio, the active material layers may be formed without affecting the overall thickness of the negative electrode plate 130a or 130b by forming the second active material layer 135a or 135b thinner than the first active material layer 134a or 134b. With consideration of the expansion ratio of silicon, under the same capacity condition the same effect may be achieved if the thickness t2 of the second active material layer 135 a or 135 b is ⅕ to ½ of the thickness t1 of the first active material layer 134a or 134b. For example, if the thickness t2 of the second active material layer 135a or 135b is in a range from ⅕ to ½ of the thickness t1 of the first active material layer 134a or 134b, it may be possible to prevent lithium ion plating and by-product deposition.

As described above, the negative electrode plate including two negative electrode active material layers may be applied to a wound-type or stacked-type electrode assembly.

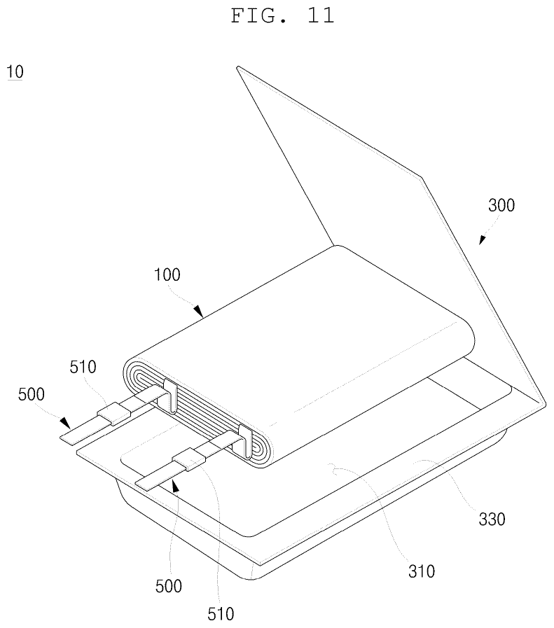

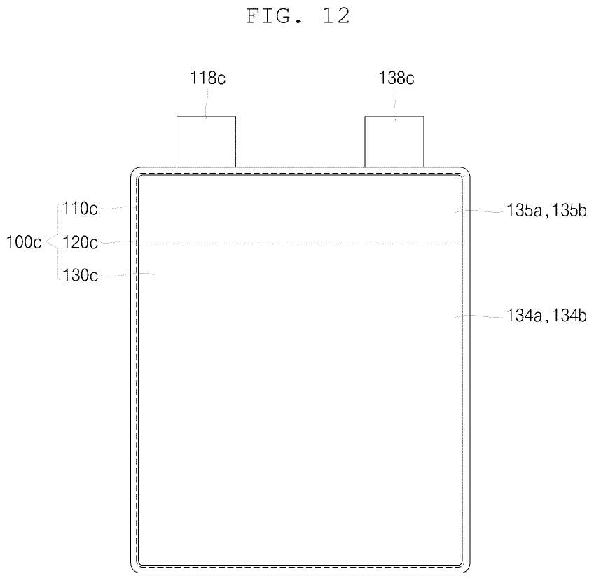

FIG. 10 is a perspective view of an exemplary electrode assembly to which the negative electrode plate according to the embodiments of the present disclosure is applied. FIG. 11 is a perspective view of an exemplary secondary battery in which the electrode assembly shown in FIG. 10 is provided. FIG. 12 is a plan view of another exemplary electrode assembly to which the negative electrode plate according to the embodiments of the present disclosure is provided. For the purpose of distinguishing between processes, different reference numerals are used for the negative electrode plates shown in FIGS. 5 and 6. However, because the negative electrode plates manufactured through the processes shown in FIGS. 5 and 6 have the same structure, a single reference numeral will be used hereinafter.

Referring to FIG. 10, a wound-type electrode assembly 100 may include, or be referred to as an electrode group, an electrode body, or a jelly roll. The electrode assembly 100 may include a positive electrode plate 110, a negative electrode plate 130a having the above-described structure, and a separator 120. The electrode assembly 100 may be wound with the separator 120 interposed between the positive electrode plate 110 and the negative electrode plate 130a.

The positive electrode plate 110 may include a positive electrode substrate 112 formed as a metal foil, a positive electrode active material layer 114 provided on at least one surface of the positive electrode substrate 112, and a positive electrode uncoated portion 116 where the positive electrode active material layer 114 is not provided. The positive electrode uncoated portion 116 may be notched to form one or more positive electrode tabs 118.

In some embodiments, as the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode plate 130a may include a negative electrode substrate 132a formed as a metal foil, negative electrode active material layers 134a and 135a (or 134b and 135b) provided on at least one surface of the negative electrode substrate 132a, and a negative electrode uncoated portion 136a where the negative electrode active material layers 134a and 135a (or 134b and 135b) are not provided. The negative electrode uncoated portion 136a may be notched to form one or more negative electrode tabs 138a.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator 120 may be interposed between the positive electrode plate 110 and the negative electrode plate 130a to prevent short circuit between the positive electrode plate 110 and the negative electrode plate 130a. For example, the separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

The electrolyte solution for a rechargeable lithium battery may include a non-aqueous organic solvent and a lithium salt.

The non-aqueous organic solvent may serve as a medium for transmitting ions taking part in the electrochemical reaction of a battery. The non-aqueous organic solvent may be a carbonate-based, ester-based, ether-based, ketone-based, or alcohol-based solvent, an aprotic solvent, or a combination thereof, and may be used alone or in combination of two or more types.

Additionally, when using a carbonate-based solvent, a cyclic carbonate and a chain carbonate may be used in combination.

The above-described wound-type electrode assembly may be used in a pouch-type secondary battery, a cylindrical secondary battery, or the like. Hereinafter, a pouch-type secondary battery will be described as an example of a secondary battery.

Referring to FIG. 11, the secondary battery 10 may include an electrode assembly 100, a pouch-type case 300, lead tabs 500, and insulating members 510.

The electrode assembly 100 may be the same as described in the foregoing embodiments. The electrode assembly 100 may be fixed in the case 300 using an adhesive or adhesive tape. The electrode assembly 100 may be accommodated in the case 300 together with an electrolyte.

The case 300 may be referred to as a laminate exterior member, a case, a pouch exterior member, or a pouch case. The case 300 may be formed by bending a plate-shaped exterior member such that two opposite surfaces face each other. A recess 310 may be formed in one of the two opposite surfaces of the case 300 through a pressing or drawing process. The electrode assembly 100 may be accommodated in the recess 310. A sealing portion 330 may be formed along the outer periphery of the recess 310. In the state in which the electrode assembly 100 is accommodated in the recess 310, the above-described positive and negative electrode tabs may be welded to the lead tabs 500. In this configuration, the plurality of positive electrode tabs may be grouped and subjected to a primary welding process. The plurality of negative electrode tabs may also be grouped and subjected to a primary welding process. Such positive and negative electrode tabs may be connected to the respective lead tabs 500, and the lead tabs 500 may be exposed outside of the pouch 300. The insulating members 510 may be provided at contact portions between the lead tabs 500 and the sealing portion 330. The insulating members 510 may be a tape made of an insulating material. The lead tabs 500 may be insulated from the case 300 by the insulating members 510. After the insulating members 510 are attached to the lead tabs 500, sealing using the sealing portion 330 may be performed. The surface of the pouch 300 facing the recess 310 may be fixed to the electrode assembly 100 using the aforementioned adhesive or adhesive tape.

FIG. 12 is a plan view of another exemplary electrode assembly in which the negative electrode plate according to the embodiments of the present disclosure is used. FIG. 12 shows the shape of a stacked-typed electrode assembly 100c among the embodiments shown in FIGS. 5 to 9 when viewed from above. A detailed description of the features that are the same as those of the embodiment shown in FIG. 10 will be omitted. The stacked-type electrode assembly 100c may be configured such that a positive electrode plate 110c, a separator 120c, and a negative electrode plate 130c are stacked. The stacking may be performed in the order of the positive electrode plate 110c, the separator 120c, the negative electrode plate 130c, the separator 120c, the positive electrode plate 110c, the separator 120c, and so on. In other embodiments, the stacking order of the positive electrode plate 110c and the negative electrode plate 130c may be reversed.

The positive electrode plate 110c may include a positive electrode substrate formed as a metal foil, a positive electrode active material layer provided on at least one surface of the positive electrode substrate, and a positive electrode uncoated portion where the positive electrode active material layer is not provided. The positive electrode uncoated portion may be notched in a predetermined shape to form one or more positive electrode tabs 118c.

The negative electrode plate 130c may include a negative electrode substrate formed as a metal foil, negative electrode active material layers 134a and 135a (or 134b and 135b) provided on at least one surface of the negative electrode substrate, and a negative electrode uncoated portion where the negative electrode active material layers 134a and 135a (or 134b and 135b) are not provided. The negative electrode uncoated portion may be notched in a predetermined shape to form one or more negative electrode tabs 138c.

The stacked-type electrode assembly 100 may be used in the pouch-type secondary battery 10 described above. In other embodiments, the stacked-type electrode assembly 100 may also be used in a prismatic secondary battery in which a prismatic can serves as a case.

As is apparent from the above description, in embodiments of the present disclosure an active material having a low expansion ratio during charging/discharging may be applied to a region near a negative electrode tab, thereby preventing by-product deposition and lithium ion plating that may otherwise occur near the negative electrode tab on which current is concentrated. Further, a high-capacity active material may be applied to a region other than the region near the negative electrode tab, thereby achieving high energy density.

However, aspects and features of the present disclosure are not limited to those described above, and other aspects and features not mentioned will be clearly understood by a person skilled in the art from the detailed description, described below.

While the disclosure has been hereinabove described in connection with embodiments and drawings, the disclosure is not limited thereto and it should be understood that various changes and modifications may be made by those skilled in the art within the spirit and scope of the disclosure.

What is claimed is:

1. An electrode assembly comprising:
a positive electrode plate;
a negative electrode plate comprising (i) a negative electrode substrate, (ii) a negative electrode active material layer formed as a coating in two regions of the negative electrode substrate, with the two regions comprising different active materials, and (iii) a negative electrode uncoated portion not provided with the negative electrode active material layer; and
a separator interposed between the positive electrode plate and the negative electrode plate.

2. The electrode assembly as claimed in claim 1, wherein the negative electrode plate further comprises a negative electrode tab formed by notching the negative electrode uncoated portion.

3. The electrode assembly as claimed in claim 2, wherein the negative electrode plate, the positive electrode plate, and the separator are wound with the separator interposed between the positive electrode plate and the negative electrode plate.

4. The electrode assembly as claimed in claim 2, wherein each of the negative electrode plate, the positive electrode plate, and the separator is provided in plural, and
wherein the plurality of negative electrode plates, the plurality of positive electrode plates, and the plurality of separators are stacked with each of the plurality of separators interposed between one of the plurality of positive electrode plates and one of the plurality of negative electrode plates.

5. The electrode assembly as claimed in claim 3, wherein the negative electrode tab is disposed on one side of the negative electrode plate.

6. The electrode assembly as claimed in claim 5, wherein the negative electrode active material layer comprises:
a first active material layer formed by coating with a first material; and
a second active material layer formed by coating with a second material.

7. The electrode assembly as claimed in claim 6, wherein the second active material layer is disposed adjacent to the negative electrode tab.

8. The electrode assembly as claimed in claim 7, wherein an area of the first active material layer is larger than an area of the second active material layer.

9. The electrode assembly as claimed in claim 8, wherein the second material has a larger lithium storage capacity than the first material.

10. The electrode assembly as claimed in claim 9, wherein the first material comprises graphite, and
wherein the second material comprises silicon or a mixture including silicon.

11. The electrode assembly as claimed in claim 10, wherein a length of the second active material layer is less than a length of the first active material layer in a longitudinal direction of the negative electrode tab.

12. The electrode assembly as claimed in claim 11, wherein the length of the second active material layer is 5% to 50% of the length of the first active material layer.

13. The electrode assembly as claimed in claim 12, wherein a thickness of the second active material layer is less than a thickness) of the first active material layer in a direction perpendicular to the longitudinal direction of the negative electrode tab.

14. The electrode assembly as claimed in claim 13, wherein the thickness of the second active material layer is 20% to 50% of the thickness of the first active material layer.

15. The electrode assembly as claimed in claim 3, wherein a plurality of the negative electrode tab is provided, and
wherein the positive electrode plate comprises a plurality of positive electrode tabs.

16. The electrode assembly as claimed in claim 4, wherein each of the negative electrode plates comprises at least one negative electrode tab, and
wherein each of the positive electrode plates comprises at least one positive electrode tab.

17. A secondary battery comprising:
a case; and
an electrode assembly accommodated in the case, the electrode assembly comprising: a positive electrode plate, a negative electrode plate, and a separator interposed between the positive electrode plate and the negative electrode plate, with the negative electrode plate comprising (i) a negative electrode substrate, (ii) a negative electrode active material layer formed as a coating in two regions of the negative electrode substrate, with the two regions comprising different active materials, and (iii) at least one negative electrode tab disposed on one side of the negative electrode active material layer.

18. The secondary battery as claimed in claim 17, wherein the negative electrode active material layer comprises:
a first active material layer formed by coating with a first material; and
a second active material layer formed by coating with a second material having a larger lithium storage capacity than the first material.

19. The secondary battery as claimed in claim 18, wherein the second active material layer is disposed adjacent to a negative electrode tab.

20. The secondary battery as claimed in claim 19, wherein an area of the first active material layer is larger than an area of the second active material layer.
